(19) United States
(12) Patent Application Publication
(10) Pub. No.: US 2009/0326725 A1
(43) Pub. Date: Dec. 31, 2009

(54) Managing Electric Power Consumption

(76) Inventors: Michael James Carlson, Minnetonka, MN (US); Raymond E. Gogel, Castle Rock, CO (US); John R. Bryan, Denver, CO (US)

Correspondence Address: MERCHANT & GOULD PC, P.O. BOX 2903, MINNEAPOLIS, MN, 55402-0903, US

(21) Appl. No.: 12/466,534

(22) Filed: May 15, 2009

Related U.S. Application Data
(60) Provisional application No. 61/054,355, filed on May 19, 2008.

(51) Int. Cl. G06F 1/28; G06Q 30/00; G06Q 10/00; G06Q 50/00

(52) U.S. Cl. 700/291; 705/412; 705/34; 700/295; 700/297

(57) ABSTRACT

A system for monitoring and managing electric power consumption at a customer location includes a plurality of devices located at various points on a mains distribution network at the customer location, each of the devices being programmed to monitor electric power consumption, and a central processing device located at the customer location, the central processing device being programmed to receive the electric power consumption information from the devices, analyze the electric power consumption information, and manage future electric power consumption based on the electric power consumption information.

### RELATED APPLICATION(S)

This application claims the benefit of U.S. patent application Ser. No. 61/054,355 filed on May 19, 2008, the entirety of which is hereby incorporated by reference.

### BACKGROUND

A utility company typically generates and distributes electricity to customers on a cost-per-unit basis. Electrical power consumption is frequently measured by a basic electric utility meter located on the customers' premises. For example, a watt-hour meter, an instrument developed in the late nineteenth century and still in use today, mechanically records instantaneous power consumption on a series of dials. Newer meters use solid-state electronics to record such usage. Subsequently, the electric utility meter is read and processed for customer billing purposes.

Electric utility meter technology requires perpetual investment in the installation and maintenance of the meters. Further, as the electric utility industry moves to next-generation power distribution grids designed to increase power distribution efficiency and address environment issues, further investment will be necessary to upgrade dated meters to work with the new grid technologies.

### SUMMARY

In example embodiments, a system for monitoring and managing electric power consumption at a customer location includes a plurality of devices located at various points on a mains distribution network at the customer location, each of the devices being programmed to monitor electric power consumption, and a central processing device located at the customer location, the central processing device being programmed to receive the electric power consumption information from the devices, analyze the electric power consumption information, and manage future electric power consumption based on the electric power consumption information.

### DESCRIPTION OF THE DRAWINGS

FIG. 1 shows an example a power generation, distribution, and consumption system.

FIG. 2 shows an example power management and distribution device.

FIG. 3 shows a plurality of the power monitoring and management devices of FIG. 2 incorporated into a customer location.

FIG. 4 shows an example computer system programmed to access electric power consumption information.

FIG. 5 shows example method for monitoring and billing for electric power consumption.

### DETAILED DESCRIPTION

The present disclosure relates to systems and methods for monitoring and managing electrical power consumption. In example embodiments, the systems include one or more data monitoring and/or managing devices that are positioned at one or more locations in a mains distribution network at a customer location to intelligently monitor and/or manage electrical power consumption.

In some embodiments, the devices are part of a smart grid that enables a utility company to optimize electricity generation and distribution, while also allowing a customer to actively manage electricity consumption. While the present disclosure is not so limited, an appreciation of the various aspects of the disclosure will be gained through a discussion of the examples provided below.

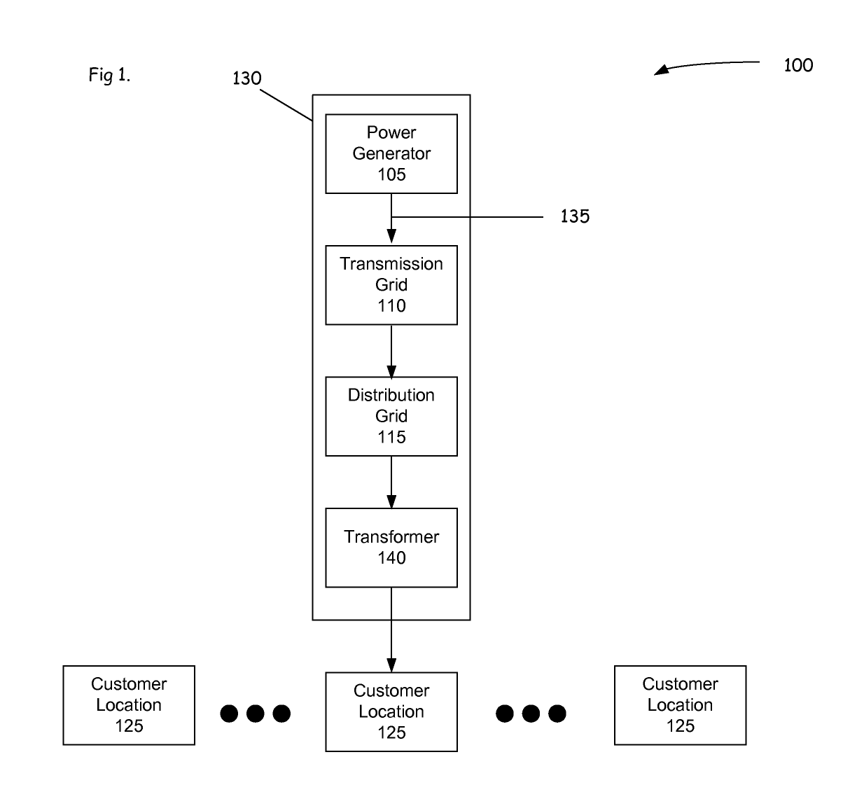

Referring now to FIG. 1, an example power distribution system 100 is shown. The system 100 includes an electric utility company 130 that generates and/or transmits electricity to a plurality of customer premises or locations 125. Each customer location 125 can be a residential location or a commercial location, such as a business or industrial complex. Other configurations are possible.

A centralized power generation facility 105 converts one form of energy (e.g., coal, wind, solar, etc.) into electrical potential energy, commonly expressed in terms of a voltage (V). In example embodiments, the power generation facility 105 is a large scale, sinusoidal (AC) voltage generator. AC voltage generation can be preferable due to the ease with which the AC voltage can be changed, herein referred to as conditioned, from one level to another via a voltage transformer, as explained further below.

The power generation facility 105 transfers electricity via a conditioned AC line voltage 135 to a transmission grid 110 configured as a standard 3-phase electrical power system. Closer to the customer location 125, the electricity is transferred to a distribution grid 115 for short-range transmission to the customer locations 125. The electrical power delivered to each of the customer locations 125 is typically converted to a single phase configuration via a transformer 140 located near or at the customer location 125. Other configurations are possible.

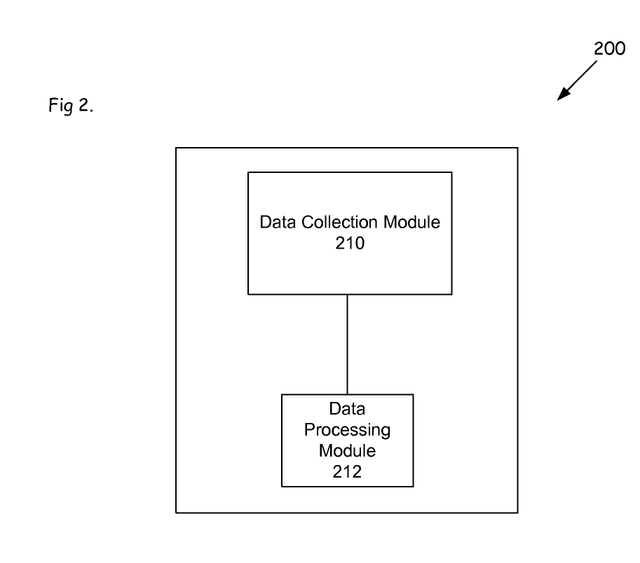

Referring now to FIG. 2, an example power monitoring and/or management device 200 is shown. In embodiments described herein, one or more of the devices 200 are located at or near each of the customer locations 125. The device 200 is configured to monitor and/or manage electricity consumption on the customer location 125.

The device 200 includes a data collection module 210 and an optional data processing module 212. In the example embodiment shown, the data collection module 210 is programmed to monitor electricity usage. For example, in some embodiments, the data collection module 210 measures voltage, current, and time as electrical power is consumed at the customer location 125.

The data processing module 212 is programmed to record and analyze electric power consumption information. For example, in one embodiment, the data collection device 210 is configured to monitor electric power consumption, and the data processing module 212 is configured to process the consumption. In some embodiments, the processed information can be communicated from the customer's location 125 to the electric utility 130.

In some embodiments, the device 200 includes a printed circuit board (not shown) having processor, memory (volatile and/or non-volatile), and supporting integrated and discrete circuitry to acquire, process, and relay electric power consumption information. In the example shown, the data collection module 210 includes circuitry that is configured to measure voltage or current parameters associated with electricity usage at the customer locate 125. In some embodiments, the data processing module 212 includes network circuitry to facilitate a wireless or a hardwired network connection that allows the electric utility 130 and/or the customer at customer location 125 to monitor and/or read the relevant power consumption information generated by the device 200, as described further below.

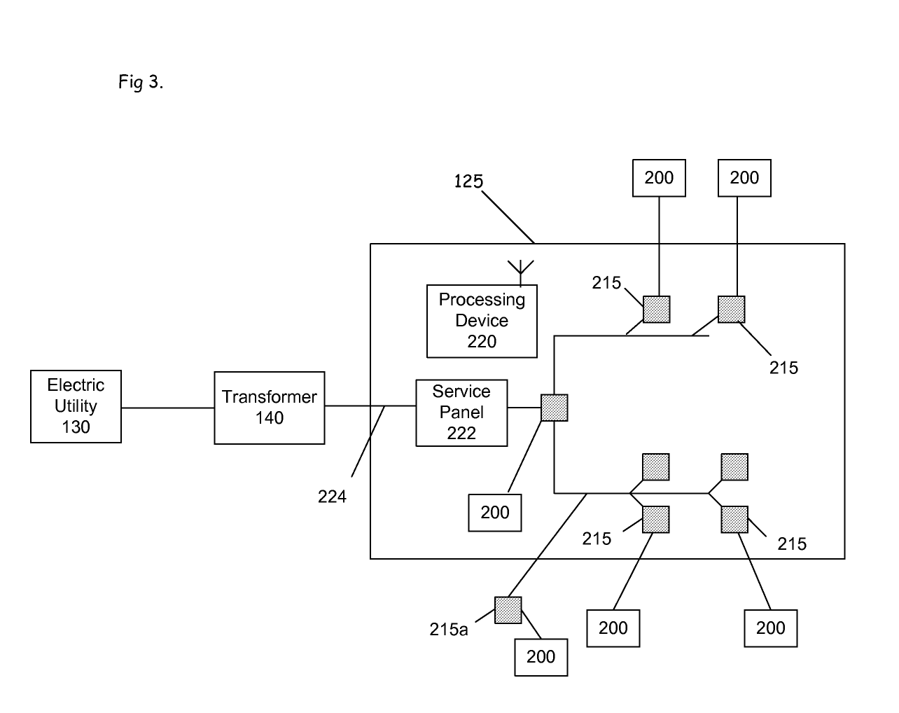

Referring now to FIG. 3, a plurality of the power monitoring and/or management devices 200 is disposed at various locations in a mains distribution network 224 of the customer location 125. In the case of a residential customer, the mains distribution network 224 generally begins at the point in the distribution grid 115 where the transformer 140 located near or at the customer location 125 converts three phase power to the single phase configuration.

In general, the devices 200 can be located at various points on the mains distribution network 224. For example, the devices 200 can be positioned at a plurality of points 215 throughout the customer location 125. The points 215 can be, for example, at each electrical outlet or at one or more appliances (e.g., dishwasher, refrigerator, air-conditioner, etc.) located at the customer location 125. In other examples, the devices 200 can be incorporated into one or more circuits within a service panel 222 on the customer location 125. Other example locations include distribution circuit breakers, switches, reclosers, distribution transformers, and secondary busses. Other configurations are possible.

The devices 200 can be used to monitor and manage power consumption. For example, each device 200 can monitor power consumption by an appliance. In some examples, the device 200 can also reduce electric power provided to an application if the appliance exceeds a certain threshold of electric power consumption.

In the embodiment shown, the devices 200 communicate the power consumption information by wired (e.g., broadband over power lines (BPL)) or wireless technologies to an optional data processing device 220. The data processing device 220 can, in turn, calculate usage and billing information and/or communicate the information to the electric utility 130. In some examples, the data processing device 220 is located at the customer location 125. For example, the data processing device 220 can be incorporated into the service panel 222 located at the customer location 125. Other configurations are possible.

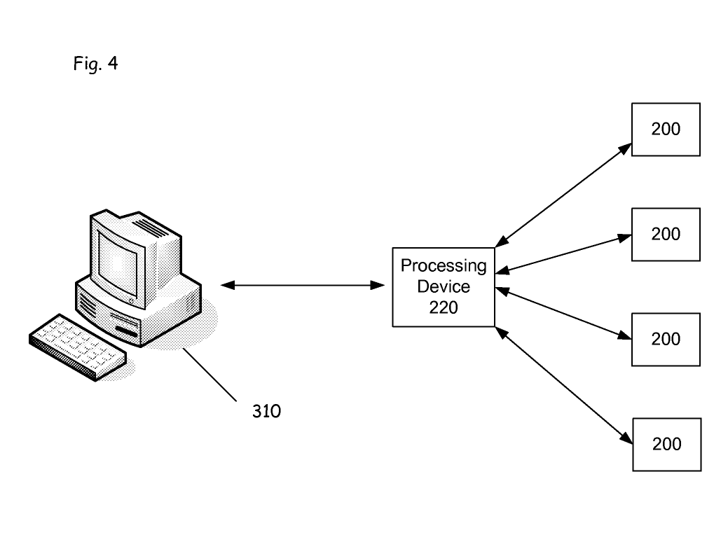

In one embodiment, the devices 200 are located at a sufficient number of points within the customer location 125 to accurately estimate and record the customer's electrical usage. This power usage is stored for a specified period of time (e.g., a week, month, quarter, etc.), and the power usage is then used to bill the customer for the energy consumption, as described below. In addition, in some embodiments, the resulting power consumption information can be communicated to the customer to allow the customer to manage power consumption (see FIG. 4).

In another embodiment, the devices 200 are located at a sufficient number of points within the customer location 125 to monitor power usage to compare to a threshold for a given period of time. For example, a threshold can be defined for power consumption over a specific period of time, such as a day, week, month, or quarter. The devices 200 monitor power consumption at the customer location 125 over the relevant period of time. If the threshold is exceeded, various processes can be implemented, such as shutting down further electrical power consumption, limiting further power consumption, and/or charging an additional rate for further consumption at the customer location 125.

In another example shown in FIG. 3, a point 215a can be located outside the structure(s) located on the customer locations 125. In this example, the point 215a is associated with a vehicle, such as a plug-in hybrid electric vehicle (PHEV), that is recharged using the mains distribution network 224 of the customer location 125. A device 200 is associated with the point 215a so that the energy consumption of the PHEV can be monitored. For example, in one embodiment, the device 200 is incorporated into the

In such embodiments described with reference to FIG. 3, the customer can be billed at a flat rate for consumption up to and not exceeding the defined threshold. In other examples, multiple usage tiers can be defined, and billing is based on the highest usage tier exceed for a given period.

Referring now to FIG. 4, in some embodiments the processing device 220 is programmed to communicate with a computer system 310. In example embodiments, the customer can operate the computer system 310 to review and manage power consumption for the customer location 125. For example, the processing device 220 is programmed to analyze and store electric power consumption information associated with the customer location 125. The customer can use computer system 310 to access the information from the processing device 220.

In example embodiments, the processing device 220 is networked so that the computer system 310 can access the processing device 220 locally or through a network such as the Internet. The computer system 310 can include one or more applications that interface with the processing device 220 to receive and present the electric power consumption information to the customer. For example, in one embodiment, the computer system 310 includes a web browser that communicates with the processing device 220 to allow the consumer to review power consumption information and to reconfigure the processing device 220.

In some examples, the customer can also program the processing device 220 to reconfigure power consumption for the customer location 125. For example, the customer can determine electric power consumption on a per-circuit or per-appliance basis, and can reduce or increase the power provided to the circuit or appliance accordingly. The customer can define threshold limits on power consumption on a per- device 200 basis, or for sections or the entire customer location 125. The processing device 220 can monitor consumption and manage electricity if the threshold is exceeded.

In other examples, the processing device 220 can be programmed to bill the customer electronically by sending an electronic invoice to the computer system 310. Electronic payment can also be received and processed from the computer system 310. In this manner, billing information need not be sent to the central utility 130 for processing.

In some embodiments, the processing device 220 includes non-volatile memory that stores consumption information and billing information. This information can be stored for a predetermined period of time such that the customer's consumption can be audited by accessing the information on the processing device 200, if needed. In other examples, the processing device 220 can be programmed to periodically send information to a central data repository for storage or otherwise have a long-term data backup.

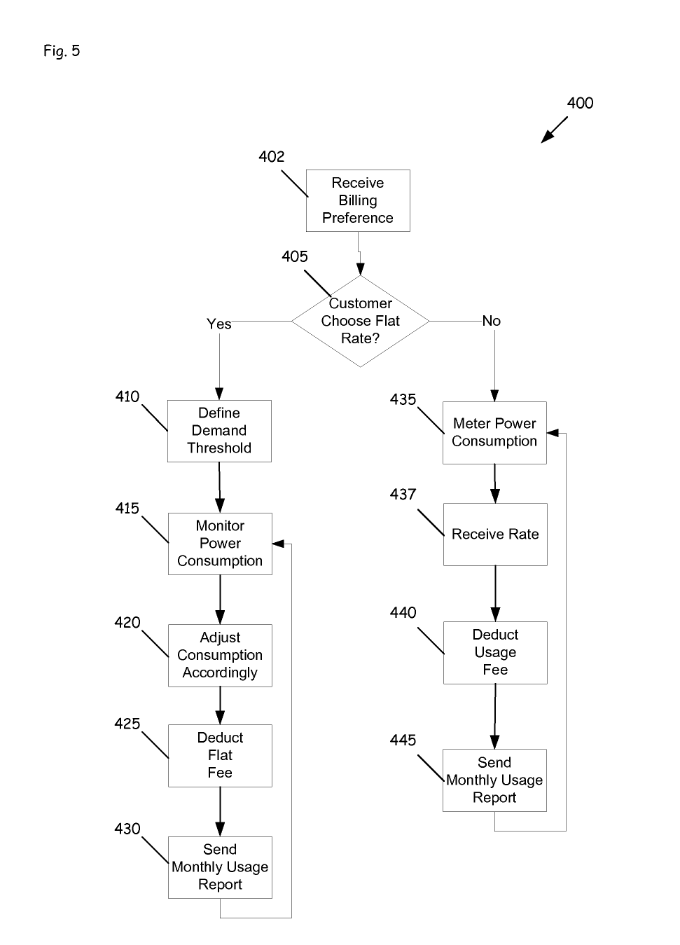

Referring now to FIG. 5, an example method 400 for monitoring and managing customer electric power consumption is detailed.

Initially, at operation 402, the customer's billing preferences are received. In the example shown, the customer can select between flat and usage-based (i.e., cumulative) billing schemes.

Next, at operation 405, a determination is made as to whether the customer selected the flat rate billing scheme. If the flat rate billing method was selected, control is passed to operation 410. At operation 410, a high threshold demand level is defined for the customer. In some embodiments, the threshold can be selected by the customer or can be defined based on historical electrical usage. In other examples, multi-tiered thresholds can be defined.

Next, at operation 415, the customer power consumption is monitored over the relevant usage period. For example, the devices 200 are used to estimate electrical usage at the customer location. At operation 420, the customer's electricity consumption is limited if the consumption approaches or exceeds the defined threshold(s). Next, at the end of the billing cycle, a flat fee is deducted at operation 425, and the customer is notified of the details of the monthly power consumption usage at operation 430 through a paper or electronic invoice. Control is then passed back to operation 415 to begin monitoring of energy consumption for the next period.

Returning to operation 405 of the method 400, if the customer chooses a cumulative-based billing scheme, control is instead passed to operation 435 and energy consumption is metered on a per-unit basis. For example, a sufficient number of the monitoring and management devices are located within the mains distribution network at the customer location to measure voltage or current to provide an accurate reflection of power consumption to provide billing-quality consumption data.

Next, at operation 437, the cost for energy consumption is received. For example, in some embodiments, the electric utility periodically (e.g., monthly, quarterly, semi-annually, or annually) sends the current rate that is charged for energy consumption. For example, the electric utility can electronically send the cost per kilowatt hour for electricity consumption to the processing device in the customer location. The processing device is programmed to use this rate to calculate the bill for the customer. In other embodiments, the consumption is sent to the electric utility for billing purposes.

At the end of a periodic billing cycle, control is then passed to operation 440, and a fee is deducted based on electricity usage. For example, the customer can be charged the bill as calculated by the processing device. The customer is notified regarding the details of the monthly power consumption usage at 445. In addition, in some embodiments, consumption information is also sent to the electric utility. This information can include, for example, total consumption for the period, as well as other information such as rate of consumption, customer changes to the system that modify system attributes and/or consumption, and billing information.

Control is then passed back to operation 435 to begin metering of energy consumption for the next period.

One or more advantages are associated with the systems and methods described herein. For example, the devices allow the customer to have a better understanding and control of electrical consumption at the customer's location. Also, the elimination of the meter at each location allows the utility company to provide more flexible billing arrangements, as well as to reduce the expenditures associated with the deployment and servicing of traditional meters. In some examples, processing of usage information and billing can be done at the customer location, thereby reducing the need for the gathering of usage information at a centralized location for billing purposes.

In alternative embodiments, the monitoring and management devices can be replaced with a single device that is incorporated into the transformer associated with the customer's location (e.g., transformer 140) to monitor and/or manage energy consumption. In yet another embodiment, a single device is incorporated into the service panel at the customer location to monitor and/or manage energy consumption. Other configurations are possible.

In another alternative embodiment, the central processing device is eliminated, and each monitoring and management device communicates directly with the utility company. The customer can access electric power consumption and billing information by contacting the utility company using, for example, a computer to access a web site hosted by the utility company.

The preceding embodiments are intended to illustrate without limitation the utility and scope of the present disclosure. Those skilled in the art will readily recognize various modifications and changes that may be made to the embodiments described above without departing from the true spirit and scope of the disclosure.

What is claimed is:

1. A system for monitoring and managing electric power consumption at a customer location, the system comprising:
a plurality of devices located at various points on a mains distribution network at the customer location, each of the devices being programmed to monitor electric power consumption; and
a central processing device located at the customer location, the central processing device being programmed to receive the electric power consumption information from the devices, analyze the electric power consumption information, and manage future electric power consumption based on the electric power consumption information;
wherein the system is configured to bill at a flat rate for the electric power consumption at the customer location up to and not exceeding a defined threshold.

2. The system of claim 1, wherein one or more of the devices are associated with an appliance located at the customer location to monitor electric power consumption of the appliance.

3. The system of claim 1, wherein one or more of the devices are associated with one or more of the following located at the customer location: a dishwasher; a refrigerator; an air-conditioner; and a plug-in hybrid electric vehicle.

4. The system of claim 1, wherein one or more of the devices are incorporated into one or more circuits within a service panel at the customer location.

5. The system of claim 1, wherein the flat rate is based on multiple usage tiers, and billing is based on a highest usage tier exceed for a given period.

6. The system of claim 1, wherein the system is also configured to allow a customer associated with the customer location to select one or more usage-based billing schemes.

7. The system of claim 6, wherein the central processing device is configured to estimate the electric power consumption using data from the devices to calculate a bill for the usage-based billing schemes.
